(19) United States
(12) Patent Application Publication
(10) Pub. No.: US 2011/0031787 A1
(43) Pub. Date: Feb. 10, 2011

(54) GET A GRIP GRAB HANDLE

(76) Inventor: Steven R. Bounds, Stanwood, WA (US)

Correspondence Address: DLC PATENTS, PLLC, 13032 CRATER LAKE CIRCLE, RIVERTON, UT, 84065, US

(21) Appl. No.: 12/853,725

(22) Filed: Aug. 10, 2010

Related U.S. Application Data
(60) Provisional application No. 61/273,780, filed on Aug. 10, 2009.

(51) Int. Cl. A47C 31/00; B25G 1/10; B23P 11/00

(52) U.S. Cl. 297/183.1; 16/430; 29/428

(57) ABSTRACT

One example embodiment includes a grab handle for a user to grip. The grab handle includes a handle, where the handle includes a rod and a cover, where the cover is placed over a portion of the rod and includes a squeezable material. The grab handle also includes a base, where the base supports the handle and allows the handle to rotate in at least one plane, and a connection means, where the connection means are configured to connect the base to an armrest.

### CROSS-REFERENCE TO RELATED APPLICATIONS

This application claims the benefit of and priority to U.S. Provisional Patent Application Ser. No. 61/273,780 filed on Aug. 10, 2009, which application is incorporated herein by reference in its entirety.

### BACKGROUND OF THE INVENTION

Getting dental work done can cause a high amount of anxiety for many people. Even when the procedure is relatively benign or pain free, the patient may have a high stress level because of anticipated pain. Often, the patient moves or fidgets in the dental chair. The movement can help relieve some of the patients stress. However, the movement can cause the dentist to have difficulty in doing the precise work required.

The increased movement can cause the dentist to poke the patient while striving to do some dental procedure or incorrectly perform a dental procedure. This can, in turn, cause the dentist to have to perform additional work or take longer than normal to complete the work. For example, if the patient is getting his/her teeth cleaned, a relatively pain free procedure for most patients, the patient might be anxious and move a great deal, causing the cleaning to take longer than average.

Additionally, even if the patient does not intend to move, the movement may be involuntary as the patient anticipates pain. For example, the patient may see the dentist insert a dental instrument into his/her mouth. The patient may then tense in anticipation of the dental work to be done. The patient may even tense simply to avoid unnecessary movement. Either way, the patient has become tense.

Often, the movement occurs out of simple boredom, as the patient feels confined for a period of time while the dental work is being performed. That is, even if the patient is unconcerned about the possibility of pain, the patient might still move because of the monotony of remaining in the dental chair.

Accordingly, it would be beneficial to have a system that would allow the patient to have something to hold onto if anticipating pain. In addition, it would be beneficial to the patient to have something to squeeze when nervous.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a grab handle for a user to grip. The grab handle includes a handle, where the handle includes a rod and a cover, where the cover is placed over a portion of the rod and includes a squeezable material. The grab handle also includes a base, where the base supports the handle and allows the handle to rotate in at least one plane, and a connection means, where the connection means are configured to connect the base to an armrest.

Another example embodiment includes a method of manufacturing a grab handle for a user to grip. The method includes providing a handle, where the handle includes a rod and a cover, where the cover is placed over a portion of the rod and includes a squeezable material. The method also includes providing a base, where the base supports the handle and allows the handle to rotate in at least one plane, and providing a connection means, where the connection means are configured to connect the base to an armrest.

Another example embodiment includes a grab handle for a user to grip. The grab handle includes a handle. The handle includes a rod, where the rod includes a first end and a second end, and a cover, where the cover is placed over the second end of the rod and includes a squeezable material. The handle also includes a cross-bar, where the crossbar is located near the second end. The grab handle also includes a base, where the base includes a first attachment point and a second attachment point. The base is configured to receive the cross-bar of the handle and allow the handle to rotate in at least one plane. The grab handle further includes a strap, where the strap includes a first end and a second end, where the first end of the strap is configured to connect to the first attachment point and where the second end of the strap is configured to connect to the second attachment point.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a front view of a grab handle;

FIG. 1B illustrates a side view of the grab handle;

FIG. 2A illustrates a front view of a base;

FIG. 2B illustrates a top view of the base;

FIG. 2C illustrates a perspective view of the base;

FIG. 3 illustrates an example of a handle; and

FIG. 4 is a flow chart illustrating a method of manufacturing a grab handle for a user to grip.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

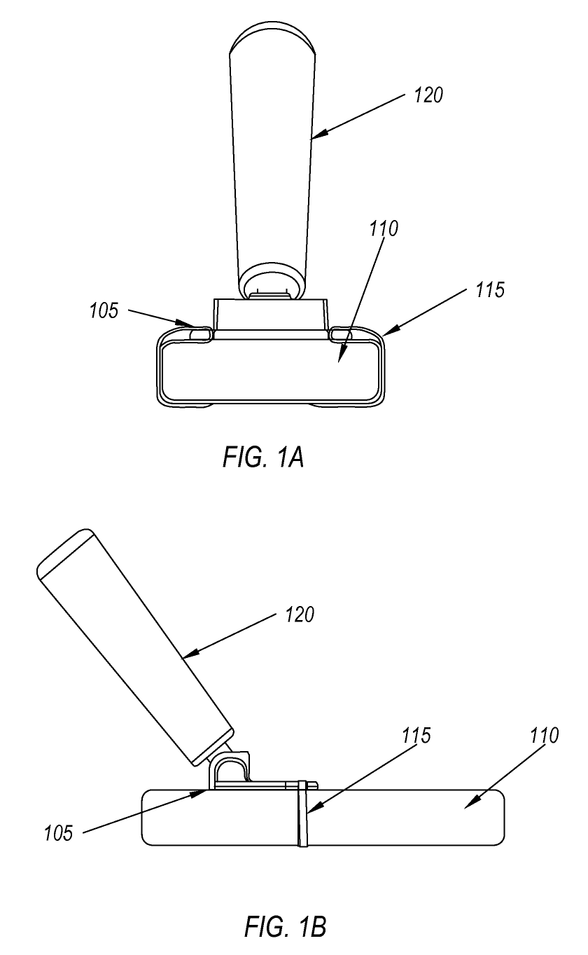

FIGS. 1A and 1B illustrate a grab handle 100 for a user to grip. FIG. 1A illustrates a front view of the grab handle 100; and FIG. 1B illustrates a side view of the grab handle 100. In at least one implementation, the grab handle 100 allows a user to have something to grip and squeeze when sitting in a chair. For example, a user can grip and squeeze the grab handle 100 while sitting in a chair during a dental procedure.

FIGS. 1A and 1B show that the grab handle 100 includes a base 105. In at least one implementation, the base 105 is configured to attach to the armrest 110 of a chair as described below. The base 105 can include a bottom surface that is flat or that is slightly curved to match the top of the armrest 110, as described below. Additionally or alternatively, the bottom surface of the base can be configured to mate to a plate that has been installed inside the armrest 110 of the chair.

In at least one implementation, the armrest 110 is a place for the person sitting in a chair to place his/her arms. In particular, the armrest 110 is raised from the chair seat to allow the user to comfortably rest his/her arms while sitting in the chair. The armrest 110 can be made of the same material as the chair or can be made of different material. The armrest 110 can be adjustable to allow the user to place it at a preferred height. The armrest 110 can be attached to a dental chair or any other chair where a user can use the stress reducing benefits of the grab handle 100.

FIGS. 1A and 1B show that the grab handle 100 can also include a strap 115 for attaching the base 105 to the armrest 110. In at least one implementation, the strap 115 connects to the base 105 at a first end goes around the armrest 110 and connects to the base 105 at a second end. The strap 115 can be configured to be adjustable, so that the strap 115 can fit around armrests 110 of different sizes. For example, the strap 115 can include hook and loop fasteners, snaps or some other mechanism which allows the strap 115 to be tightened securely around the armrest 110.

Additionally or alternatively, the base 105 can be attached directly to the armrest 110. For example, the base 105 can be matched to a plate that is pre-installed in the armrest 110 and can include one or more bolt holes. I.e., one or more bolts can be threaded through the base 105 directly into the armrest 110. Additionally or alternatively, the armrest 110 could include one or more clamps to attach the base 105.

FIGS. 1A and 1B also show that the grab handle 100 can include a handle 120. The handle 120 can be made of a squeezable material, allowing the user to squeeze the handle when nervous. The handle 120 can be sized to comfortably fit in the hand of a user. I.e., the user can wrap his/her hand around the handle 120 and squeeze the handle 120 when nervous. For example, during a dental procedure a user can squeeze and pull against the handle 120 to help keep still and to alleviate nervousness.

In at least one implementation, the handle 120 is configured to rotate in at least one plane. I.e., the handle 120 can rotate from flat against the base 105 or flat against the armrest 110 to perpendicular to the base 120. Rotation of the handle 120 can allow a user to move the handle 120 from a position where the handle 120 is put away to a position where the handle 120 can be used by the user.

In at least one implementation, the grab handle 100 can further include a lock. The lock can be used to hold the position of the handle 120 relative to the base 105. I.e., the lock can prevent movement of the handle 120. The lock can include a mechanism that automatically locks the handle in position or can include a lock that can be manually engaged by a user. For example, the lock can include a screw that can be tightened by the user when the handle is in a preferred position.

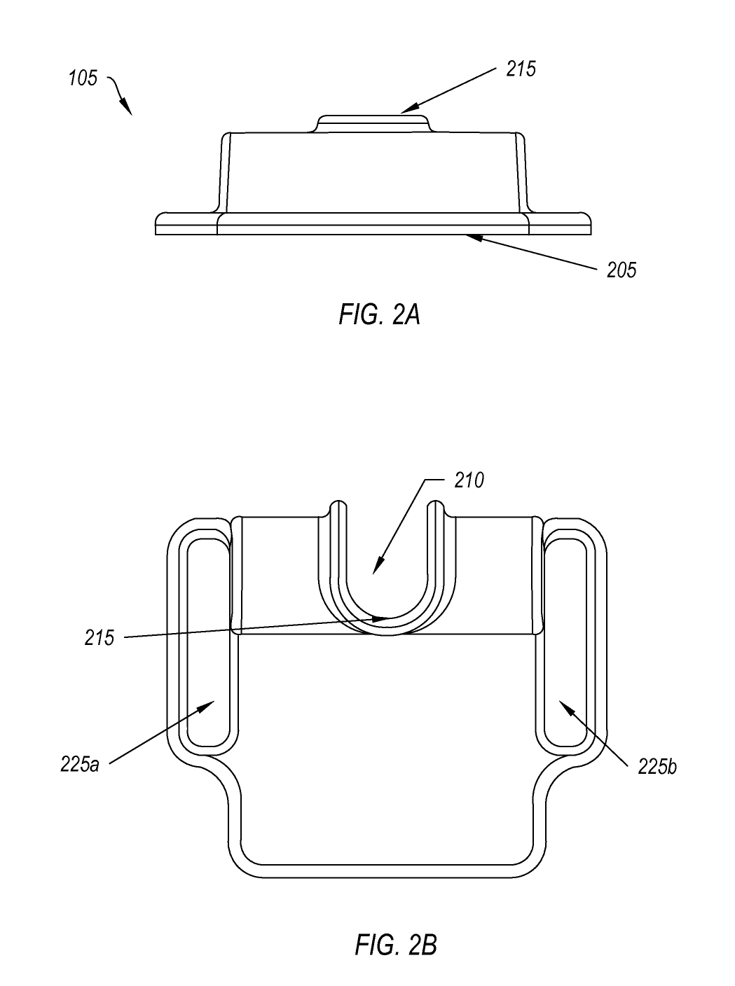

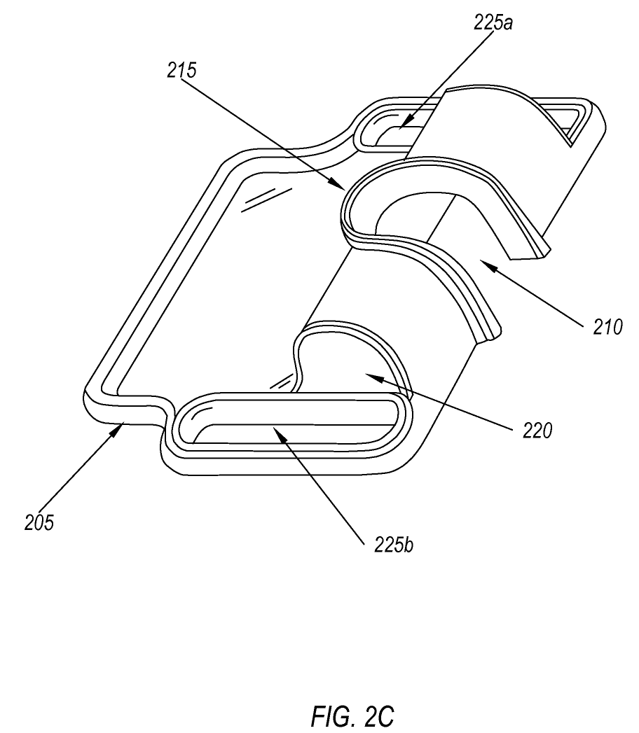

FIGS. 2A, 2B and 2C illustrate an example of a base 105. FIG. 2A illustrates a front view of the base 105; FIG. 2B illustrates a top view of the base 105; and FIG. 2C illustrates a perspective view of the base 105. In at least one implementation, the base 105 can be used to secure the grab handle 100 of FIG. 1.

FIGS. 2A, 2B and 2C show that the base 105 can include a bottom surface 205. In at least one implementation, the bottom surface 205 is configured to sit on the armrest of a chair. For example, the bottom surface 205 can be slightly curved or otherwise shaped to rest on an armrest. In particular, the bottom surface can be shaped to match the shape of the top of the armrest. Additionally or alternatively, the bottom surface 205 can be shaped and sized to mate with a plate pre-installed in the armrest.

FIGS. 2A, 2B and 2C show that the base 105 can include a guide 210. In at least one implementation, the guide 210 can be configured to allow movement of a handle, as discussed above. The guide 210 can be used to constrain the motion of the handle to a single plane or can allow movement of the handle in multiple directions.

FIGS. 2A, 2B and 2C also show that the base 105 can include a stop 215. In at least one implementation, the stop 215 can be used to stop the motion of the handle. For example, as the user becomes tense and pulls on the handle, the stop 215 can prevent the handle from moving too far. I.e., the stop 215 can provide tension when the user pulls on the handle.

FIGS. 2A, 2B and 2C further show that the base 105 can include a coupling 220. In at least one implementation, the coupling 220 is configured to attach a handle to the base 105. In particular, a portion of the handle can be inserted into the coupling 220 to secure the handle. Additionally or alternatively, the coupling 220 can allow the handle to rotate relative to the base 105, as discussed above.

FIGS. 2A, 2B and 2C also show that the base 105 can include a first attachment point 225a and a second attachment point 225b (collectively “attachment points 225”). In at least one implementation, the attachment points 225 can be used to attach the base 105 to an armrest. For example, a first end of a strap can be connected to the base 105 at the first attachment point 225a. The strap can then be placed around the armrest and a second end of the strap can be connected to the base 105 at the second attachment point 225b. The strap can be configured to be adjustable, so that the strap can fit around armrests of different sizes.

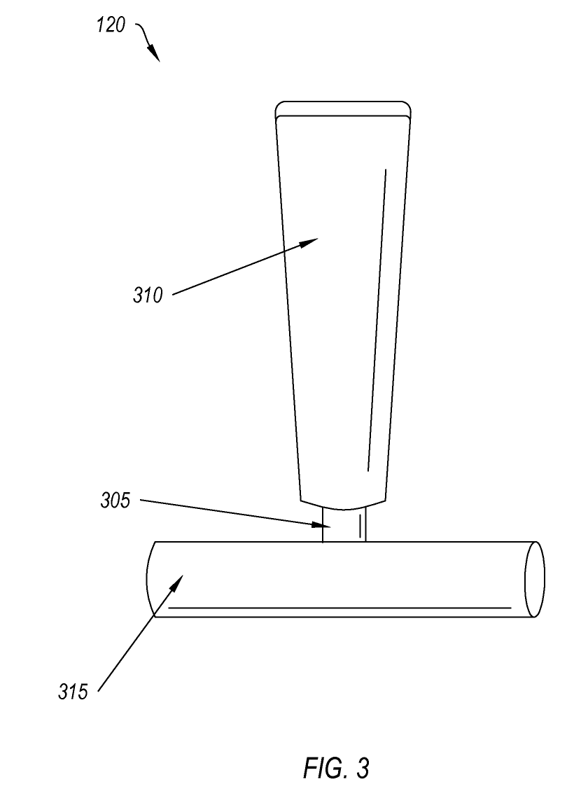

FIG. 3 illustrates an example of a handle 120. In at least one implementation, a user can pull against or squeeze the handle 120. For example, the handle 120 can be connected to an armrest to allow the user to pull against or squeeze the handle 120 when nervous.

FIG. 3 shows that the handle 120 can include a rod 305. In at least one implementation, the rod 305 can form the central part of the handle 120. The rod 305 can provide strength to the handle 120. Additionally or alternatively, the rod 305 can allow the handle to rotate relative to a base, as described above. The rod 305 can include any material that has sufficient strength to withstand the pressure of a user pulling on the handle 120. For example, the rod 305 can include injection molded plastic, metal, wood or any other material of sufficient strength.

FIG. 3 also shows the handle 120 can include a cover 310. In at least one implementation, the cover 310 can at least partially cover one end of the rod 305. The cover 310 can include a covering that is removable from the rod 305 or can be continuous with the rod 305. For example, the rod 305 and the cover 310 can be a single piece or can be different pieces.

The cover 310 can include a squeezable material. As used in the claims and the specification, the term squeezable material shall refer to a material which is compressible under pressure, unless otherwise specified. That is, a squeezable material is one that a user can squeeze and that will compress under the pressure. For example, the cover 310 can include foam rubber, cloth, compressible plastic or any other squeezable material.

FIG. 3 further shows that the handle 120 can include a cross-bar 315. In at least one implementation, the cross-bar 315 can be located at one end of the rod 305. The cross-bar 315 can be perpendicular to the rod 305. The rod 305 can be attached at the mid-point of the cross-bar 315 to provide maximum support for the rod 305. The cross-bar can be continuous with the rod 305. For example the rod 305 and the cross-bar 315 can be a single piece or can be different pieces connected to one another.

In at least one implementation, the cross-bar 315 can be used to connect the handle 120 to a base. For example, the cross-bar 315 can be inserted into the coupling 220 of the base shown in FIG. 2. The cross-bar 315 can be round to allow the handle 120 to rotate relative to the base.

Additionally or alternatively, the handle 120 could include a different means for attaching the handle 120 to a base and allow the handle 120 to rotate relative to the base. For example, the handle 120 could include a spherical piece on the end of the rod.

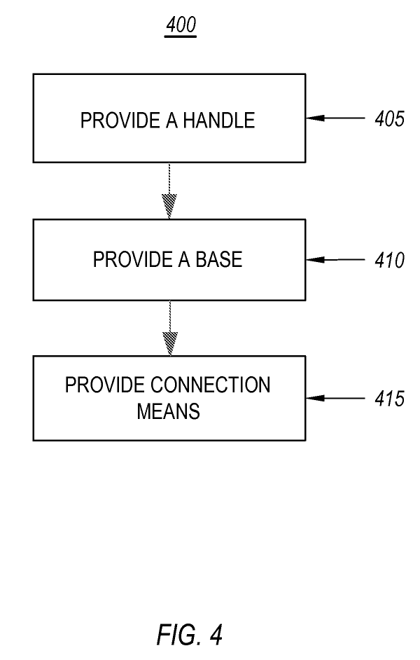

FIG. 4 is a flowchart illustrating a method 400 of manufacturing a grab handle for a user to grip. One of skill in the art will appreciate that the method 400 can be used to produce the grab handle 100 of FIG. 1; however, the method 400 can be used to produce grab handles other than the grab handle 100 of FIG. 1.

FIG. 4 shows that the method 400 can include providing a handle 405. In at least one implementation, a user can pull against or squeeze the handle. For example, the handle can be connected to an armrest to allow the user to pull against or squeeze the handle when nervous.

In at least one implementation, the handle can include a rod. The rod can form the central part of the handle. In particular, the rod can provide strength to the handle. Additionally or alternatively, the rod can allow the handle to rotate relative to a base, as described above. The rod can include any material that has sufficient strength to withstand the pressure of a user pulling on the handle. For example, the rod can include injection molded plastic, metal, wood or any other material of sufficient strength.

In at least one implementation, the handle can include a cover. In particular, the cover can at least partially cover one end of the rod. The cover can include a covering that is removable from the rod or can be continuous with the rod. For example, the rod and the cover can be a single piece or can be different pieces. The cover can include a squeezable material.

In at least one implementation, the handle can include a cross-bar. In particular, the cross-bar can be located at one end of the rod. The cross-bar can be perpendicular to the rod. The rod can be attached at the mid-point of the cross-bar to provide maximum support for the rod. The cross-bar can be continuous with the rod. For example the rod and the cross-bar can be a single piece or can be different pieces connected to one another.

In at least one implementation, the cross-bar can be used to connect the handle to a base. For example, the cross-bar can be inserted into the coupling of a base. The cross-bar can be round to allow the handle to rotate relative to the base. Additionally or alternatively, the handle could include a different means for attaching the handle to a base and allow the handle to rotate relative to the base. For example, the handle could include a spherical piece on the end of the rod.

In at least one implementation, the handle can be sized to comfortably fit in the hand of a user. I.e., the user can wrap his/her hand around the handle and squeeze the handle when nervous. For example, during a dental procedure a user can squeeze and pull against the handle to help keep still and to alleviate nervousness.

In at least one implementation, the handle is configured to rotate in at least one plane. I.e., the handle can rotate from flat against the base or flat against the armrest to perpendicular to the base. Rotation of the handle can allow a user to move the handle from a position where the handle is put away to a position where the handle can be used by the user.

FIG. 4 also shows that the method 400 includes providing a base 410. In at least one implementation, the base 105 can be used to secure the grab handle to an armrest or to another location. The base can include a bottom surface. In particular, the bottom surface can be configured to sit on the armrest of a chair. For example, the bottom surface can be slightly curved or otherwise shaped to rest on an armrest. In particular, the bottom surface can be shaped to match the shape of the top of the armrest. Additionally or alternatively, the bottom surface can be shaped and sized to mate with a plate pre-installed in the armrest.

In at least one implementation, the base can include a guide. In particular, the guide can be configured to allow movement of a handle, as discussed above. The guide can be used to constrain the motion of the handle to a single plane or can allow movement of the handle in multiple directions.

In at least one implementation, the base can include a stop. In particular, the stop can be used to stop the motion of the handle. For example, as the user becomes tense and pulls on the handle, the stop can prevent the handle from moving too far. I.e., the stop can provide tension when the user pulls on the handle.

In at least one implementation, the base can include a coupling. In particular, the coupling is configured to attach a handle to the base. In particular, a portion of the handle can be inserted into the coupling to secure the handle. Additionally or alternatively, the coupling can allow the handle to rotate relative to the base, as discussed above.

In at least one implementation, the base can include a first attachment point and a second attachment point. In particular, the attachment points can be used to attach the base to an armrest. For example, a first end of a strap can be connected to the base at the first attachment point. The strap can then be placed around the armrest and a second end of the strap can be connected to the base at the second attachment point. The strap can be configured to be adjustable, so that the strap can fit around armrests of different sizes.

FIG. 4 shows that the method 400 can include providing connection means 415. In at least one implementation, connection means can be configured to connect the base to the arm rest. For example, the connection means can include a strap for attaching the base to the armrest. In at least one implementation, the strap connects to the base at a first end goes around the armrest and connects to the base at a second end. The strap can be configured to be adjustable, so that the strap can fit around armrests of different sizes. For example, the strap can include hook and loop fasteners, snaps or some other mechanism which allows the strap to be tightened securely around the armrest.

Additionally or alternatively, the base can be attached directly to the armrest. For example, the base can be matched to a plate that is pre-installed in the armrest and can include one or more bolt holes. I.e., one or more bolts can be threaded through the base directly into the armrest. Additionally or alternatively, the armrest could include one or more clamps to attach the base.

In at least one implementation, the method 400 can further include providing a lock. The lock can be used to hold the position of the handle relative to the base. I.e., the lock can prevent movement of the handle. The lock can include a mechanism that automatically locks the handle in position or can include a lock that can be manually engaged by a user. For example, the lock can include a screw that can be tightened by the user when the handle is in a preferred position.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A grab handle for a user to grip, the grab handle comprising:
a handle, wherein the handle includes:
a rod; and
a cover, wherein the cover is placed over a portion of the rod and includes a squeezable material;
a base, wherein the base supports the handle and allows the handle to rotate in at least one plane; and
connection means, wherein the connection means are configured to connect the base to an armrest.

2. The grab handle of claim 1, wherein the connection means includes direct attachment to the armrest.

3. The grab handle of claim 1, wherein the connection means includes a bolt, wherein the bolt is threaded through the base and the armrest.

4. The grab handle of claim 1, wherein the connection means includes a strap.

5. The grab handle of claim 4, wherein the strap includes hook and loop fasteners.

6. The grab handle of claim 1, wherein the base includes an attachment point, wherein the attachment point is configured to connect the base to the connection means.

7. The grab handle of claim 6, wherein the base includes a second attachment point, wherein the second attachment point is configured to connect the base to the connection means.

8. The grab handle of claim 1, wherein the handle includes a cross-bar.

9. The grab handle of claim 8, wherein the cross-bar is configured to connect the handle to the base.

10. The grab handle of claim 8, wherein the cross-bar is configured to allow rotation of the handle relative to the base.

11. The grab handle of claim 8, wherein the cross-bar is connected to the rod.

12. A method of manufacturing a grab handle for a user to grip, the method comprising:
providing a handle, wherein the handle includes:
a rod; and
a cover, wherein the cover is placed over a portion of the rod and includes a squeezable material;
providing a base, wherein the base supports the handle and allows the handle to rotate in at least one plane; and
providing connection means, wherein the connection means are configured to connect the base to an armrest.

13. The method of claim 12, wherein the base includes injection molded plastic.

14. The method of claim 12, wherein the base includes metal.

15. The method of claim 12, wherein the cover includes foam rubber.

16. The method of claim 12, wherein the cover is removable for cleaning.

17. A grab handle for a user to grip, the grab handle comprising:
a handle, wherein the handle includes:
a rod, wherein the rod includes a first end and a second end;
a cover, wherein the cover is placed over the second end of the rod and includes a squeezable material; and
a cross-bar, wherein the crossbar is located near the first end of the rod;
a base, wherein the base includes:
a first attachment point; and
a second attachment point; and
wherein the base is configured to:
receive the cross-bar of the handle; and
allow the handle to rotate in at least one plane; and
a strap, wherein the strap includes a first end and a second end;
wherein the first end of the strap is configured to connect to the first attachment point; and
wherein the second end of the strap is configured to connect to the second attachment point.

18. The grab handle of claim 17, further comprising:
a lock, wherein the lock is configured to lock the position of the handle relative to the base.

19. A dental chair including the grab handle of claim 17.

20. A dental chair including two grab handles of claim 17.
